(19) United States
(12) Patent Application Publication
(10) Pub. No.: US 2019/0240712 A1
(43) Pub. Date: Aug. 8, 2019

(54) REROUNDING TOOL FOR REROUNDING OF TUBULAR STRUCTURES AND THE LIKE

(71) Applicant: Leak Man Supply, LLC, Wayne, NJ (US)

(72) Inventor: Frank Semeraro, Wayne, NJ (US)

(21) Appl. No.: 16/129,139

(22) Filed: Sep. 12, 2018

Related U.S. Application Data
(60) Provisional application No. 62/627,944, filed on Feb. 8, 2018.

(51) Int. Cl. B21D 3/10; F16L 55/18; B25B 1/24

(52) U.S. Cl. CPC B21D 3/10; B25B 1/241; F16L 55/18

(57) ABSTRACT

A method for rerounding a tubular structure includes the steps of: (1) inserting the tubular structure into a rerounding tool that is in an open position, the rerounding tool having a first block with a first semi-circular trough formed therein in a first surface thereof and a second block with a second semi-circular trough formed therein in a second surface thereof, the tubular structure being laid within the first trough; and (2) closing the rerounding tool by bringing the first surface into contact with the second surface such that the tubular structure is also received within the second semi-circular trough resulting in rerounding of the tubular structure due to the first semi-circular trough and the second semi-circular trough defining a cylindrical cavity.

### CROSS REFERENCE TO RELATED APPLICATION

This application is based on and claims priority to U.S. Provisional Patent Application 62/627,944, filed Feb. 8, 2018, the entire contents of which is incorporated by reference herein as if expressly set forth in its respective entirety herein.

### TECHNICAL FIELD

The present invention relates to equipment and tools and more particularly, relates to a rerounding tool that is configured for rerounding of a tubular structure, such as copper tubing or the like.

### BACKGROUND

Metal conduits (tubing or piping) are used in a wide variety of different applications and in particular, are used in construction settings for the purpose of delivering fluids from one location to another. For example, copper tubing typically is used for potable water lines. Such copper tubing typically comes in bulk and in rolled coils. When unrolled, the copper tubing often times becomes misshaped and assumes an oblong shape and does not easily accept any necessary fittings without fabrication to the pipe diameter. There are existing rerounding products on the market, such a plier-like rerounding device that includes pivotable jaws and is commercially available from Reed Manufacturing. This device has a pair of pivotable handle jaws, with each jaw having a semi-circular shaped base portion that when combined with the other semi-circular shaped base portion of the other jaw defines, in a closed position, a complete circular shaped base portion which is intended to shape a tube that is placed between the semi-circular shaped base portions in an open position. While this type of device has some utility, there is a need to provide an alternative method and alternative rerounding tool for rerounding tubular structures, such as tubing and pipes.

### BRIEF DESCRIPTION OF THE DRAWING FIGURES

FIG. 1 is a perspective view showing a rerounding tool according to a first embodiment for rerounding a tubular structure and being shown in an open position with a first means for closing the rerounding tool;

FIG. 2 is an end elevation view of the rerounding tool of FIG. 1 with a second means for closing the rerounding tool;

FIG. 3 is a side exploded view of first and second blocks of a rerounding tool according to a first embodiment;

FIG. 4 is a plan view of the first block;

FIG. 5 is a plan view of the second block;

FIG. 6 is a cross-sectional view of the first block;

FIG. 7 is a cross-sectional view of the second block showing guide pins inserted therein;

FIG. 8 is a side exploded view of first and second blocks of a rerounding tool according to a second embodiment;

FIG. 9 is a plan view of the first block;

FIG. 10 is a plan view of the second block;

FIG. 11 is a cross-sectional view of the first block; and

FIG. 12 is a cross-sectional view of the second block showing guide pins inserted therein.

### DETAILED DESCRIPTION OF CERTAIN EMBODIMENTS

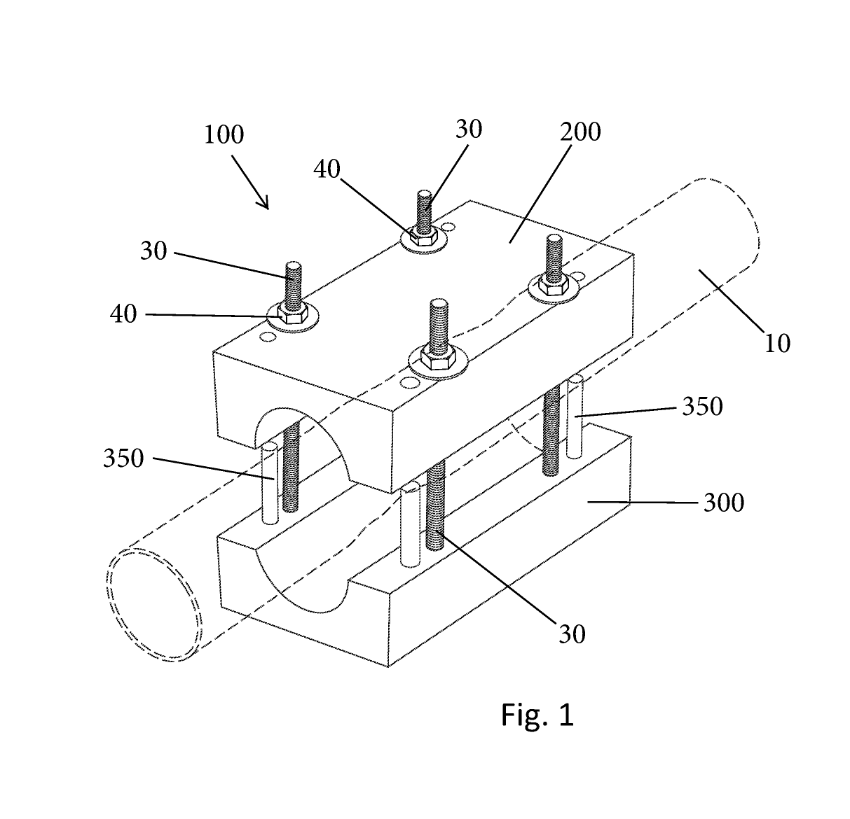

As shown in FIG. 1, the present invention is directed to a rerounding tool 100 that is configured to reround a tubular structure 10, such as a pipe, that is placed therein when the tool 100 is in a first (open) position. The rerounding tool 100 thus is configured to reround the tubular structure 10 and for straightening of the tubular structure for removal of bends and/or mild kinks, etc. More specifically, the rerounding tool 100 is configured to compress the tubular structure 10 (e.g., copper tubing) to create a circular diameter that duplicates factory specifications for the copper tubing, thus making it effortless to attach compression fittings to the copper tubing. The now perfectly round piece of pipe can be easily and accurately cut with a tubing cutter rather than with a saw which leaves jagged edges and sharp corners that can be damaging to the rubber gasket in the compression coupling. The newly rounded pipe allows for a perfect fit and placement of the compression gasket, which in turn reduces the risk of future leaks and cross threading of the compression fastener (e.g., nut) during coupler installation.

It will be appreciated that the rerounding tool 100 can be used with any number of different tubular structures 10 that are formed of suitable material that comprises materials that are compressible, pliable or otherwise bendable and manipulatable by operation of the rerounding tool 100 which causes a rerounding of the tubular structure. Thus, while copper tubing (e.g., type k copper) is discussed as being one exemplary application, it will be understood that other types of tubing can be rerounded so long as it is formed of a suitable material capable of being rerounded.

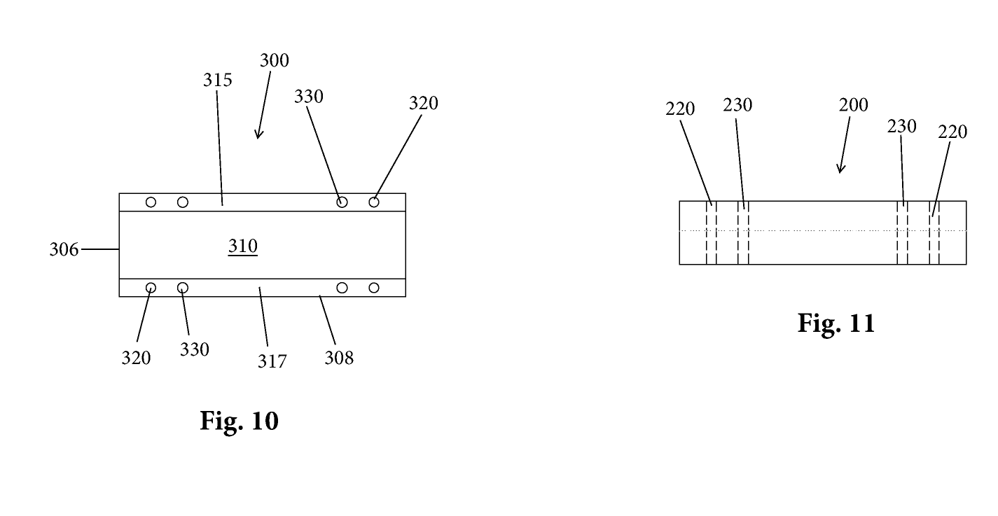

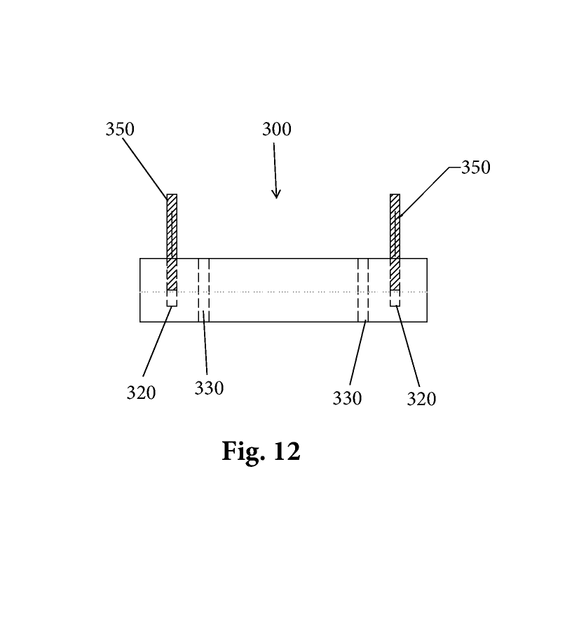

As set forth in FIGS. 1-12, the rerounding tool 100 comprises a first block (a first part or first half) 200 and a complementary second block (second part or second half) 300. The first block 200 has a first surface 202, which can be considered to be an inner surface, and an opposing second surface 204, which can be considered to be an outer surface. The second surface 204 is preferably a planar surface. The first surface 202 has a first channel 210 formed therein and as shown in the figures, the first channel 210 has a concave shape and in particular, has a semi-circular shape. The first channel 210 is sized and shaped to receive the tubular structure 10, such as copper tubing having prescribed dimensions (e.g., 1½ or 2 inch type k copper tubing). It will be appreciated that when the tubular structure is laid within the first channel 210, a portion (e.g., one half) of the tubular structure is contained within the first channel 210, while another portion (e.g., other half) protrudes above the first block 200. End walls 206 and side walls 208 that extend between the first surface 202 and the second surface 204 can be planar surfaces formed at right angles. The first block 200 can thus can the form of a rectangle or square.

The first surface 202 also includes a first planar ledge 215 formed along one edge of the first channel 210 and a second planar ledge 217 formed along the other opposite edge of the first channel 210. The first channel 210, first planar ledge 215 and second planar ledge 217 extend in the longitudinal direction of the first block 200.

The first block 200 includes a first set of holes 220 and a second set of holes 230. A plurality of the first set of holes 220 are formed in the first planar ledge 215, while a plurality of the second set of holes 230 are formed in the second planar ledge 217. For example, two holes 220 can be formed in the first planar ledge 215 and two holes 220 can be formed in the second planar ledge 217. As shown in FIG. 4, the holes 220 along the first planar ledge 215 and the holes 220 formed along the second planar ledge 217 can be considered to define two pairs of opposing holes. Similarly, two holes 230 can be formed in the first planar ledge 215 and two holes 230 can be formed in the second planar ledge 217. As shown in FIG. 4, the holes 230 along the first planar ledge 215 and the holes 230 formed along the second planar ledge 217 can be considered to define two pairs of opposing holes. The holes 220 are located closer to the ends of the first block 200 as shown in FIG. 4 and a result the holes 230 are located internally between the holes 220. It will also be understood that the holes 230 represent through holes 230 formed completely through the first block 200 while, the holes 220 can be in the form of through holes (as shown in FIG. 6) or can be closed ended holes that are open only along the first surface 202 or the opposing second surface 204.

As illustrated holes 220, 230 have circular shapes; however, other shapes are possible. The second block 300 is similar and complementary to the first block 200 and has a first surface 302, which can be considered to be an inner surface, and an opposing second surface 304, which can be considered to be an outer surface. The second surface 304 is preferably a planar surface. The first surface 302 has a second channel 310 formed therein and as shown in the figures, the second channel 310 has a concave shape and in particular, has a semi-circular shape. The second channel 310 is sized and shaped to receive a tubular structure, such as copper tubing having prescribed dimensions (e.g., 1½ or 2 inch type k copper tubing). It will be appreciated that when the tubular structure is laid within the second channel 310 and then the second block 300 is mated to the first block 200, the upper portion (e.g., upper half) of the tubular structure is received within the first channel 210. End walls 306 and side walls 308 that extend between the first surface 302 and the second surface 304 can be planar surfaces formed at right angles. The second block 300 can thus can the form of a rectangle or square.

The first surface 302 also includes a first planar ledge 315 formed along one edge of the second channel 310 and a second planar ledge 317 formed along the other opposite edge of the second channel 310. The second channel 310, first planar ledge 315 and second planar ledge 317 extend in the longitudinal direction of the second block 300.

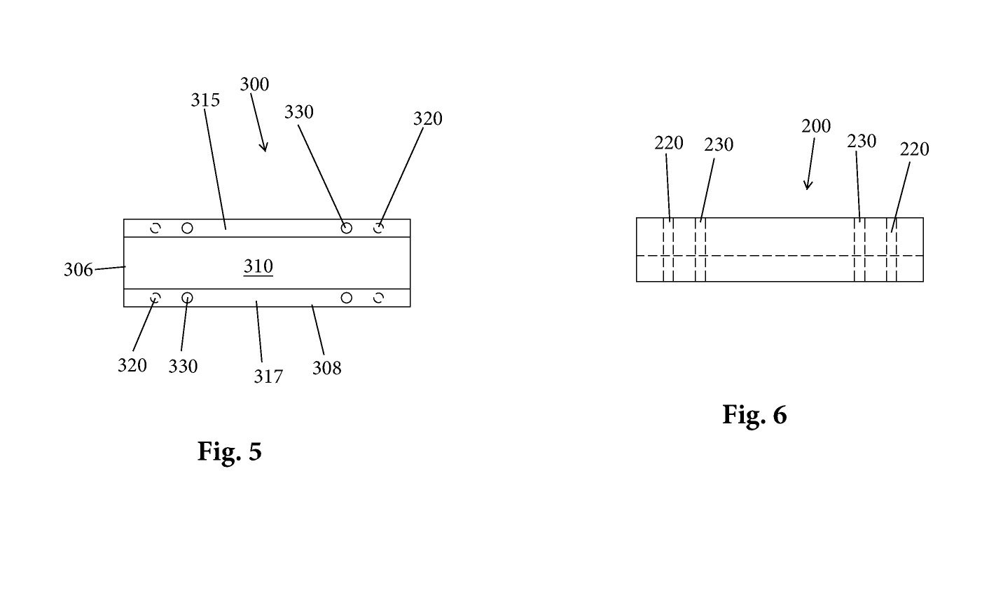

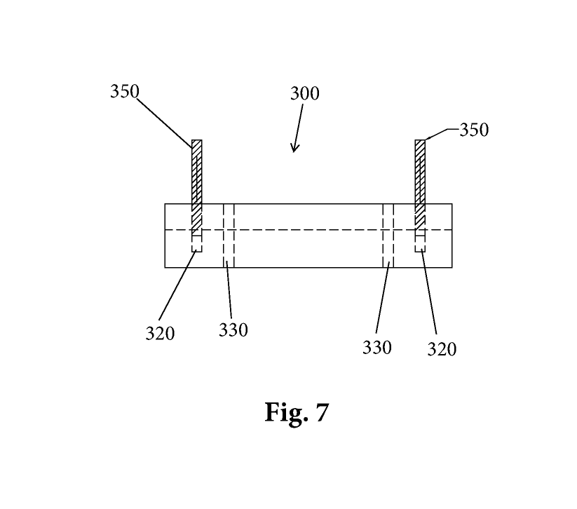

The second block 300 includes a first set of holes 320 and a second set of holes 330. A plurality of the first set of holes 320 are formed in the first planar ledge 315, while a plurality of the second set of holes 330 are formed in the second planar ledge 317. For example, two holes 320 can be formed in the first planar ledge 315 and two holes 320 can be formed in the second planar ledge 317. As shown in FIG. 5, the holes 320 along the first planar ledge 315 and the holes 320 formed along the second planar ledge 317 can be considered to define two pairs of opposing holes. Similarly, two holes 330 can be formed in the first planar ledge 315 and two holes 330 can be formed in the second planar ledge 317. As shown in FIG. 5, the holes 330 along the first planar ledge 315 and the holes 330 formed along the second planar ledge 317 can be considered to define two pairs of opposing holes. The holes 320 are located closer to the ends of the second block 300 as shown in FIG. 4 and as a result the holes 330 are located internally between the holes 320. It will also be understood that the holes 330 represent through holes 330 formed completely through the first block, while holes 320 are closed ended holes that are open only along the first surface 302 but do not extend to second surface 304 as shown in FIG. 7.

As illustrated holes 320, 330 have circular shapes; however, other shapes are possible.

As shown in FIG. 7, locator pins 350 can be inserted into the holes 320 and are sized such that an end portion of each locator pin 350 protrudes above the first surface 302 of the second block 300. The locator pins 350 (e.g., dowel pins) serve to guide and facilitate the mating of the first block 200 to the second block 300. More specifically, when the second block 300 is mated to the first block 200, the first ledge 315 abuts the first ledge 215 and similarly, the second ledge 317 abuts the second ledge 217 with the first channel 210 and the second channel 310 overlapping one another and in registration with one another as to define a circular shaped cavity that has a prescribed constant diameter along the length of the blocks 200, 300.

When the blocks 200, 300 mate together, the locator pins 350 are received within the holes 220 formed in the first block 200. This leaves through holes 230, 330 completely open and ready to receive a tightening tool/mechanism.

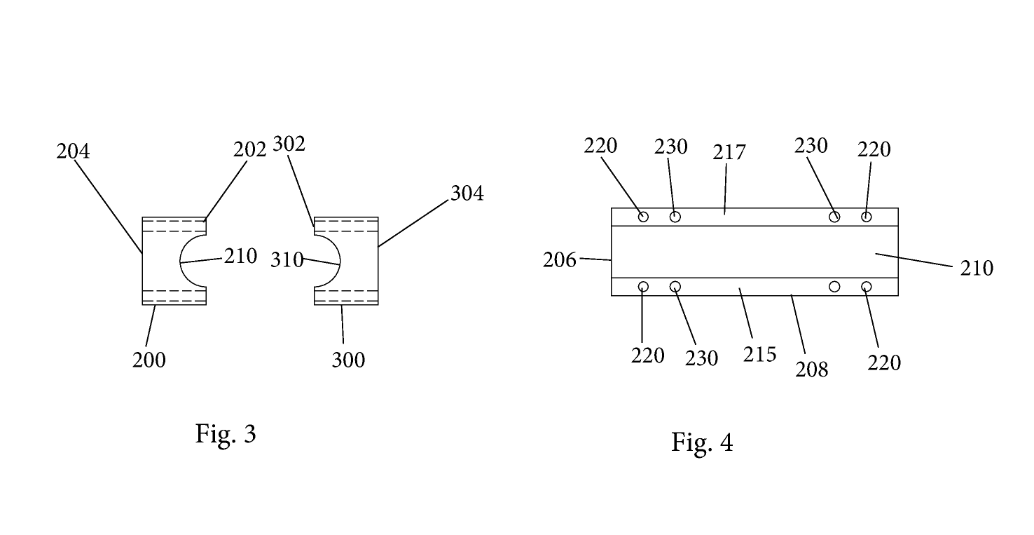

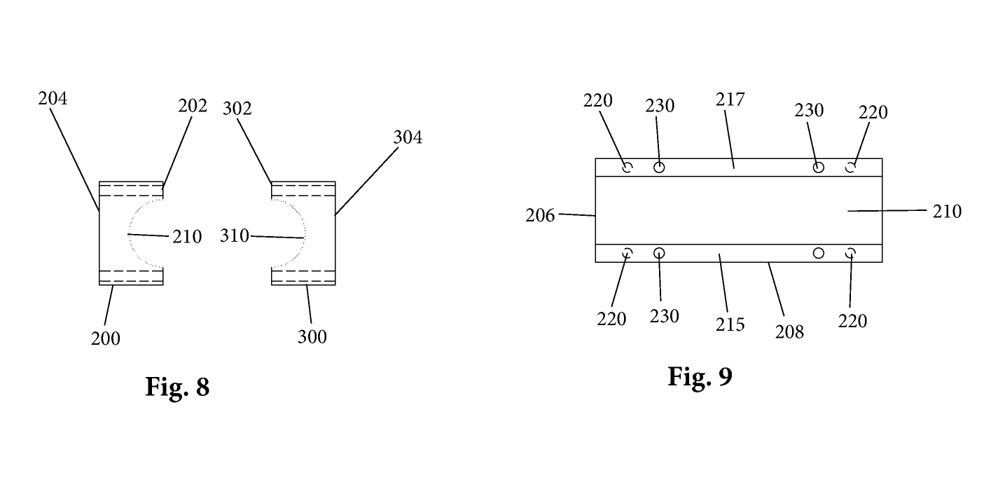

FIGS. 3-7 show the tool 100 according to a first embodiment that is configured to reround a tubular structure having a first diameter (e.g., 1½ inches) and FIGS. 8-12 show the tool 100 according to a second embodiment that is configured to receive and reround a tubular structure having a second diameter (e.g., 2 inches).

It will be appreciated that in FIGS. 3 and 8, the locator pins 350 (e.g., dowel pins) are not shown but instead the receiving holes within the blocks are shown in which the locator pins 350 are inserted and contained in the manner described herein.

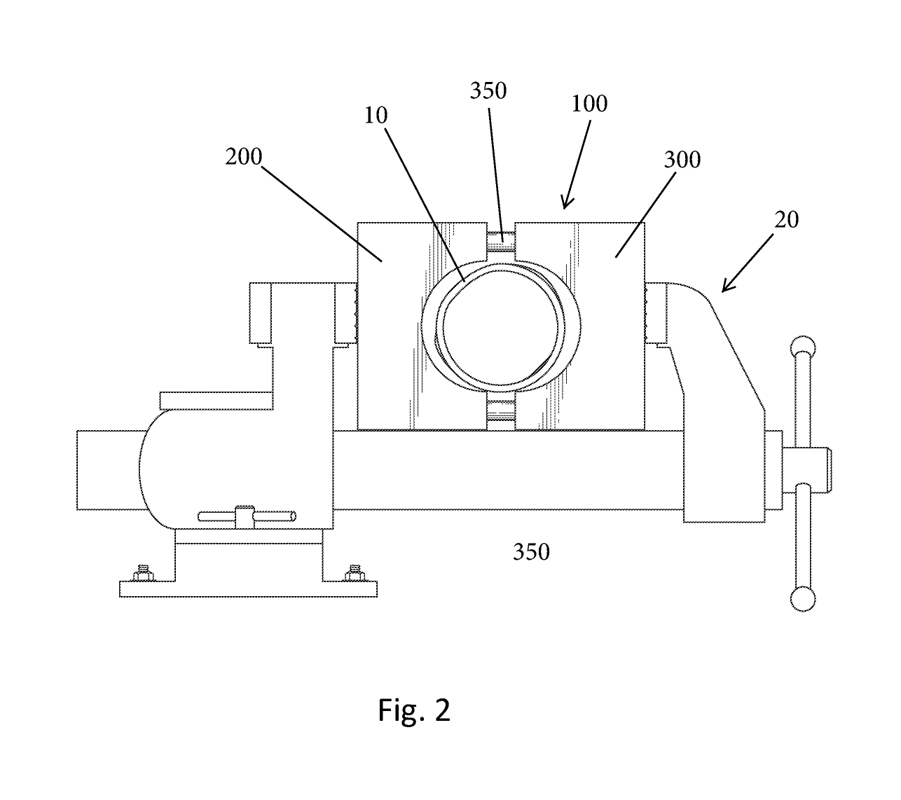

In particular, the operation of the tool 100 can be performed according to two different methods. The first method requires the use of a vise 20 as shown in FIG. 2. The tool 100 is separated into the first block 200 and the second block 300. As shown, the block 200 has guide holes 220, while the second block 300 has guide pins 350. The tubular structure (e.g., copper pipping) is placed between the two blocks 200, 300 and in particular, the tubular structure is placed in the second channel 310 with the guide pins 350 facing straight up. The first block 200 is then lined up with the second block 300 such that the guide holes 220 line up with and receive the guide pins 350. Once the first and second blocks 200, 300 are mated together with the guide pins 350 in guide holes 220, the tool 100 is placed in a vise with the jaws of the vice 20 disposed on the outside of the tool 100 with the tubular structure contained within and between the first channel 210 and the second channel 310. Be sure to place the tubular structure at the desired location length at which the tubular structure is to be rounded.

Once proper placement is achieved, the vise is compressed to where the inner surfaces 202, 302 of the blocks 200, 300 abut and are in intimate, flush contact with one another, whereby the tubular structure is rerounded. Next after the rerounding is complete, the vise is loosened and the blocks 200, 300 are separated and the rerounded tubular structure is removed from channels 210, 310. This section of the tubular structure is now ready for installation.

The second method of operation of the tool 100 following the first method of operation except that the use of a vise is not necessary. Instead, a tightening fastener, such as a bolt 30 and nut 40, is used to apply compression force to the blocks 200, 300. The steps of the first method are followed except for placement of the vise. Once the tubular structure is properly placed within the second channel 310 at the desired location length, and the two blocks 200, 300 are aligned, bolts 30 are inserted into the axially aligned holes 230, 330. The fasteners can be in the form of bolts 30 or the like that have heads that limit the degree of travel of the fasteners within the aligned holes 230, 330. For example, the heads of the fasteners 30 abut against either the outer surface 204, 304 and then nuts 40 are mated to the exposed distal ends of the fasteners that extend beyond one of the outer surfaces 204, 304. The nuts 40 are placed on the exposed distal ends of the bolts 30 and can be hand tightened. Then one or more torque generating tools, such as an open-ended wrench and socket, can be used to fully tighten the nuts. The fasteners are tightened until the inner surfaces 202, 302 of the two blocks 200, 300 abut and are in intimate contact with one another, whereby the nested tubular structure is rerounded. Once done, the nuts are loosened and the bolts removed to allow separation of the blocks 200, 300. The tubular structure is removed and the result, like the first method, is a round structure (e.g., round piece of tubing) that conforms to factor specification and is ready for installation.

According to one example, the bolts 30 can be 5/16 inch bolts and 5/16 inch nuts 40 can be used.

It will be understood that the two blocks 200, 300 of the tool 100 can be configured so as to receive any number of different sized tubular structures 10.

### EXAMPLE

The following is one exemplary implementation of the present invention is not limiting of the scope of the present invention.

The 1½″ and 2″ tools are made from 6160 square stock aluminum. The overall dimensions of each unit with both halves (blocks 200, 300) full compressed are as follows:
1½″ tool−4″H×9″L×2.75″D
2″ tool−4″H×9″L×3.25″D

Each tool 100 is separated into two pieces (blocks 200, 300) that compress together to form the whole tool 100.

Channels 201, 310 are milled straight through both blocks 200, 300 on both the 1½″ and 2″ tool. Milling depth on the 1½″ tool is 1.625″×0.8125″ on each half (block 200, 300). Milling depth on the 2″ tool is 2.125″×1.0625″ on each half (block 200, 300).

Each tool has four dowel pins 350 affixed to the bottom half (block 300) of the tool. Dowel pins 350 are cut and pressed from stainless steel. All four of the dowel pins 350 protrude 1″ from the bottom half (block 300) of the tool 100 and align to 4 guide holes 220 on the top half (block 200) of the tool 100. Each tool also comes with four 5/16″×5″ threaded grade 8 bolts with 8 washers and 4 nuts of equal and matching material.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A tool for rerounding a tubular structure comprising:
a first block having a first surface that has a first recessed channel formed therein and extending longitudinally therealong, the first surface having spaced first planer edge portions that are adjacent the first recessed channel and extend longitudinally; wherein a first set of holes are formed in the first planar edge portions; and
a second block having a second surface that has a second recessed channel formed therein and extending longitudinally therealong, the second surface having spaced second planer edge portions that are adjacent the second recessed channel and extend longitudinally;
wherein a second set of holes are formed in the second planar edge portions;
wherein each of the first recessed channel and the second recessed channel has a semi-circular shape;
a plurality of locator pins for reception in the first set of holes and the second set of holes for positioning the first block relative to the second block; and
wherein in an assembled position, the first planar edge portion seat against the second planar edge portions and the first recessed channel and the second recessed channel are superimposed to define a cylindrical shaped inner cavity for rerounding the tubular structure.

2. The tool of claim 1, wherein the first set of holes and the second set of holes are closed ended holes that do not extend completely through the first block and second block, respectively.

3. The tool of claim 1, wherein the first set of holes is formed in each of the first planar edge portions and the second set of holes is formed in each of the second planar edge portions.

4. The tool of claim 1, wherein the first block has a third set of holes formed in the first planar edge portions and the second block has a fourth set of holes formed in the second planar edge portions.

5. The tool of claim 4, wherein the third set of holes comprise through holes formed completely through the first block and the fourth set of holes comprise through holes formed completely through the second block.

6. The tool of claim 5, wherein the third set of holes are located internal relative to the first set of holes that are formed closer to opposing ends of the first block and wherein the fourth set of holes are located internal relative to the second set of holes that are formed closer to opposing ends of the second block.

7. The tool of claim 6, further including a plurality of fasteners for securing the first block to the second block by being threadingly mated to the second set of holes and the fourth set of holes.

8. The tool of claim 7, wherein the plurality of fasteners comprises a set of bolts and nuts.

9. The tool of claim 1, further including a vise that is configured to grip the first block and the second block between a pair of jaws.

10. The tool of claim 1, wherein the first planar edge portions extend along opposing sides of the first block and the second planar edge portions extend along opposing sides of the second block.

11. The tool of claim 1, wherein the locator pins comprise dowel pins.

12. A method for rerounding a tubular structure comprising the steps of:
inserting the tubular structure into a rerounding tool that is in an open position, the rerounding tool having a first block with a first semi-circular trough formed therein in a first surface thereof and a second block with a second semi-circular trough formed therein in a second surface thereof, the tubular structure being laid within the first trough; and
closing the rerounding tool by bringing the first surface into contact with the second surface such that the tubular structure is also received within the second semi-circular trough resulting in rerounding of the tubular structure due to the first semi-circular trough and the second semi-circular trough defining a cylindrical cavity.

13. The method of claim 12, further including the step of using a vice to squeeze the first block and the second block to bring the first surface into contact with the second surface.

14. The method of claim 12, further including the step of using a plurality of fasteners to attach the first block to the second block.

15. The method of claim 12, wherein the first surface having spaced first planer edge portions that are adjacent the first recessed channel and extend longitudinally; wherein a first set of holes are formed in the first planar edge portions; and the second surface has spaced second planer edge portions that are adjacent the second recessed channel and extend longitudinally; wherein a second set of holes are formed in the second planar edge portions; and a plurality of locator pins are inserted into the first set of holes and the second set of holes for positioning the first block relative to the second block.

16. The method of claim 15, wherein the first set of holes and the second set of holes are closed ended holes that do not extend completely through the first block and second block, respectively, and wherein the first set of holes is formed in each of the first planar edge portions and the second set of holes is formed in each of the second planar edge portions.

17. The method of claim 16, wherein the first block has a third set of holes formed in the first planar edge portions and the second block has a fourth set of holes formed in the second planar edge portions, wherein the third set of holes comprise through holes formed completely through the first block and the fourth set of holes comprise through holes formed completely through the second block.

18. The method of claim 17, wherein the third set of holes are located internal relative to the first set of holes that are formed closer to opposing ends of the first block and wherein the fourth set of holes are located internal relative to the second set of holes that are formed closer to opposing ends of the second block.

19. The method of claim 15, wherein the first planar edge portions extend along opposing sides of the first block and the second planar edge portions extend along opposing sides of the second block.
